(19) United States
(12) Patent Application Publication
(10) Pub. No.: US 2025/0067997 A1
(43) Pub. Date: Feb. 27, 2025

(54) EYEWEAR RETENTION SYSTEM WITH CABLE SECURING MECHANISM

(71) Applicant: Stephen Dougherty, Edgewater, FL (US)

(72) Inventor: Stephen Dougherty, Edgewater, FL (US)

(21) Appl. No.: 18/809,390

(22) Filed: Aug. 20, 2024

Related U.S. Application Data
(60) Provisional application No. 63/533,794, filed on Aug. 21, 2023.

(51) Int. Cl. G02C 5/14

(52) U.S. Cl. CPC G02C 5/143

(57) ABSTRACT

The present disclosure provides a device for securing eyewear, comprising an earpiece having a through-hole, a cable passing through the through-hole, and a securing mechanism configured to retain the cable within the through-hole. The securing mechanism may include a counterbore hole adjacent to the through-hole, configured to receive an enlarged portion of the cable, such as a melt bead formed at an end of the cable. Alternatively, the securing mechanism may comprise a threaded tap hole intersecting the through-hole and a screw configured to engage the threaded tap hole to secure the cable. In another embodiment, the securing mechanism may include a spring-loaded pivoting arm configured to engage the cable. The device allows for secure attachment of a retention cable to eyewear while maintaining a streamlined appearance.

### CROSS-REFERENCE TO RELATED APPLICATIONS

This application claims priority to U.S. Application No. 63/533,794, titled DEVICE, SYSTEM, AND METHOD FOR AN EYEWEAR HOLDER, filed 21 Aug. 2023, which is hereby incorporated by reference in its entirety.

### FIELD OF INVENTION

The present disclosure relates to eyewear retention systems, particularly eyewear retention systems with a cable securing mechanism integrated into the eyewear structure.

### BACKGROUND

The following discussion is not to be deemed admitted prior art but merely related art to show possible background and information related to an eyewear retention system.

To illustrate examples of potential embodiments without limiting their scope the following description will discuss using an eyewear retention system.

Eyewear, such as glasses and sunglasses, are widely used for vision correction, eye protection, and fashion. While eyewear provides numerous benefits, users often face challenges in keeping their eyewear secure during various activities, especially outdoor pursuits and sports.

Traditional methods for securing eyewear have included strings, cloth bands, and chains that allow the eyewear to hang around the wearer's neck when not in use. However, these solutions often prove cumbersome, unreliable, or difficult to use, particularly during dynamic activities.

The need for secure eyewear retention is particularly acute in water-based activities such as boating, fishing, and water sports. In these environments, expensive eyewear, including polarized sunglasses, can easily slip off due to wind, waves, or sudden movements, risking loss or damage.

Existing retention systems may also cause discomfort or abrasion to the wearer's ears or neck, especially during extended use. Additionally, many current solutions lack easy adjustability or the ability to be quickly removed and reattached as needed.

The eyewear industry continues to seek innovative solutions that can provide secure retention while maintaining comfort, ease of use, and adaptability to various activities and environments. Improvements in this area could enhance the user experience and protect valuable eyewear investments across a wide range of applications.

Each of these solutions fails to meet the needed solution because they are difficult to use, cumbersome, unreliable, and cannot be easily removed.

Therefore, a need exists for a novel eyewear retention system for holding eyewear while in use or when removed to keep around a wearer's neck.

### BRIEF SUMMARY OF THE INVENTION

This invention relates to a device, system, and method for an eyewear retention system with a cable-securing mechanism.

Numerous aspects of a device, system, and method for an eyewear retention system are disclosed.

A device for securing eyewear is provided. The device includes an earpiece with a through-hole, a cable passing through the through-hole, and a securing mechanism configured to retain the cable within the through-hole.

The device may include one or more of the following features. The securing mechanism may comprise a counterbore hole adjacent to the through-hole, the counterbore hole configured to receive an enlarged portion of the cable. The enlarged portion of the cable may comprise a melt bead formed at an end of the cable. The securing mechanism may comprise a threaded tap hole intersecting the through-hole and a screw configured to engage the threaded tap hole to secure the cable. The device may further comprise a screw counterbore adjacent to the threaded tap hole, the screw counterbore configured to receive a head of the screw. The securing mechanism may comprise a spring-loaded pivoting arm configured to engage the cable. The pivoting arm may include teeth configured to grip the cable.

A method for securing eyewear is provided. The method includes providing an earpiece of eyewear with a through-hole. The method also includes inserting a cable through the through-hole. The method further includes securing the cable within the through-hole using a securing mechanism.

The method may include one or more of the following features. Securing the cable may comprise forming an enlarged portion at an end of the cable and positioning the enlarged portion within a counterbore hole adjacent to the through-hole. Forming the enlarged portion may comprise melting the end of the cable to create a melt bead. Securing the cable may comprise engaging a screw within a threaded tap hole intersecting the through-hole to secure the cable. The method may further comprise positioning a head of the screw within a screw counterbore adjacent to the threaded tap hole. Securing the cable may comprise engaging a spring-loaded pivoting arm with the cable. The pivoting arm may include teeth configured to grip the cable.

According to another aspect of the present disclosure, an eyewear retention system is provided. The system includes a pair of eyeglasses having earpieces, each earpiece including a through-hole. The system also includes a cable threaded through the through-holes of both temple arms. The system further includes a means for securing the cable within each through-hole.

The eyewear retention system may include one or more of the following features. The means for securing the cable may comprise a counterbore hole adjacent to each through-hole, the counterbore hole configured to receive an enlarged portion of the cable. The enlarged portion of the cable may comprise a melt bead formed at an end of the cable. The means for securing the cable may comprise a threaded tap hole intersecting each through-hole and a screw configured to engage the threaded tap hole to secure the cable. The system may further comprise a screw counterbore adjacent to each threaded tap hole, the screw counterbore configured to receive a head of the screw. The means for securing the cable may comprise a spring-loaded pivoting arm configured to engage the cable, the pivoting arm including teeth configured to grip the cable.

### BRIEF DESCRIPTION OF THE DRAWINGS

A device, system, and method for holding eyewear is illustrated by way of example, and not by way of limitation, in the figures of the accompanying drawings.

While aspects of a device, system, and method for holding eyewear will be described with reference to the details of the embodiments of the invention shown in the drawings (and some embodiments not shown in the drawings), these details are not intended to limit the scope of the invention.

FIG. 1 illustrates a side view of an eyewear device with a cable retention mechanism, according to aspects of the present disclosure.

FIG. 2 depicts a side view of an eyewear arm with a cable retention mechanism, according to an embodiment.

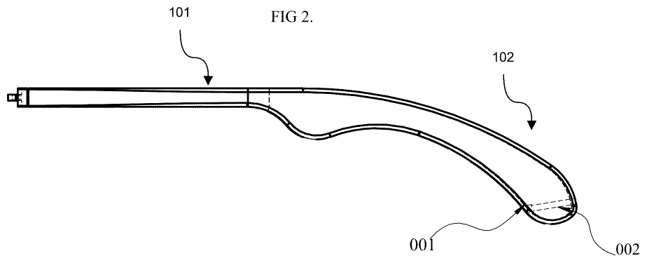

FIG. 3 illustrates a perspective view of an eyewear device with an integrated retention system, according to aspects of the present disclosure.

FIG. 4 depicts a side view of an eyewear retention device focusing on the earpiece, according to an embodiment.

FIG. 5 illustrates a side view of an eyewear retention device with a cable attachment mechanism, according to aspects of the present disclosure.

FIG. 6 depicts a perspective view of an eyewear device with a threaded retention system, according to an embodiment.

FIG. 7 illustrates a perspective view of an eyewear device with a cable retention system, according to aspects of the present disclosure.

FIG. 8 depicts a side view of an eyewear device with a screw-based retention mechanism, according to an embodiment.

FIG. 9 illustrates a side view of an eyewear temple arm with a cable retention system, according to aspects of the present disclosure.

FIG. 10 depicts a sectional view of an eyewear retention device, according to an embodiment.

FIG. 11 illustrates a side view of an eyewear retention device with a cable termination mechanism, according to aspects of the present disclosure.

FIG. 12 depicts a perspective view of a pivoting arm mechanism for eyewear retention, according to an embodiment.

FIG. 13 illustrates a perspective view of an eyewear device with a spring-loaded retention system, according to aspects of the present disclosure.

FIG. 14 depicts a side view of an eyewear device with a spring-loaded mechanism, according to an embodiment.

FIG. 15 illustrates a side view of an eyewear retention device with a pivoting mechanism, according to aspects of the present disclosure.

FIG. 16 depicts a side view of an eyewear retention device focusing on the cable attachment mechanism, according to an embodiment.

FIG. 17 illustrates a series of views depicting a process for attaching a retention cable to eyewear, according to aspects of the present disclosure.

### LIST OF FIGURE ITEMS

001—Counterbore hole
002—Through-hole
003—Melt bead
004—Cable
005—Threaded tap hole
006—Screw
007—Screw counterbore
008—Cable termination point
009—Temple arm
010—Spring
011—Spring loaded mechanism
013—Cable entrance
014—Through-hole
015—Pivoting mechanism
016—Pivoting arm catch
017—Cable termination point
101—Arm
102—Earpiece

### DETAILED DESCRIPTION

The order of the steps in the disclosed processes may be altered within the scope of the invention.

In conjunction with the accompanying drawings, the following detailed description provides a more specific and detailed explanation of various embodiments of an eyewear retention system. These embodiments are provided to illustrate the invention but should not be seen as limiting its scope; the apparatus and method can be embodied in many different forms and is intended to be thorough and comprehensive to those skilled in the art.

For the purposes of promoting an understanding of the principles of an eyewear retention system, reference will now be made to the embodiments illustrated in the drawings and specific language will be used to describe the same, only as examples and not intended to be limiting.

Various terms recognized by those skilled in the art are used herein but are not to be limiting.

The present disclosure provides an eyewear retention system designed to secure eyewear during use or when not in use. The system may include an earpiece of the eyewear, which may have a through-hole. A cable may be configured to pass through this through-hole. The system may also include a securing mechanism, which may be configured to retain the cable within the through-hole. The securing mechanism may take various forms, including but not limited to a counterbore hole adjacent to the through-hole, a threaded tap hole intersecting the through-hole, or a spring-loaded pivoting arm. In some embodiments, the cable may have an enlarged portion, such as a melt bead, which may be received by the counterbore hole. In other embodiments, a screw may be used to secure the cable within the threaded tap hole. The spring-loaded pivoting arm may be configured to engage the cable, providing another means of securing the cable within the through-hole. The disclosed eyewear retention system may offer a lightweight, easy-to-use, and adjustable solution for securing eyewear during various activities.

An eyewear retention system may have the following components: (1) a counterbore hole 001, (2) a through-hole 002, (3) a melt bead 003, (4) a cable 004, (5) a threaded tap hole 005, (6) a screw 006, (7) a screw counterbore 007, (8) a cable termination point 008, (9) a temple arm 009, (10) a spring 010, (11) a spring loaded mechanism 011, (12) a cable entrance 013, (13) a through-hole 014, (14) a pivoting mechanism 015, (15) a pivoting arm catch 016, (16) a cable termination point 017, (17) an arm 101, (18) an earpiece 102.

The components of the eyewear retention system may be generally connected together as follows: The arm 101 and earpiece 102 may form the main structure of the eyewear's temple. A through-hole 002 may be incorporated into the earpiece 102, through which a cable 004 may pass. Adjacent to the through-hole 002, a counterbore hole 001 may be positioned to accommodate a melt bead 003 formed at the end of the cable 004. In some cases, a threaded tap hole 005 may intersect the through-hole 002, allowing a screw 006 to secure the cable 004. The screw 006 may be recessed within a screw counterbore 007. Alternatively, a spring-loaded mechanism 011 may be integrated into the temple arm 009, incorporating a spring 010 and a pivoting mechanism 015. This mechanism may include a pivoting arm catch 016 to grip the cable 004. The cable 004 may enter the system through a cable entrance 013 and terminate at a cable termination point 008 or 017. In some embodiments, an additional through-hole 014 may be present to accommodate various cable routing options.

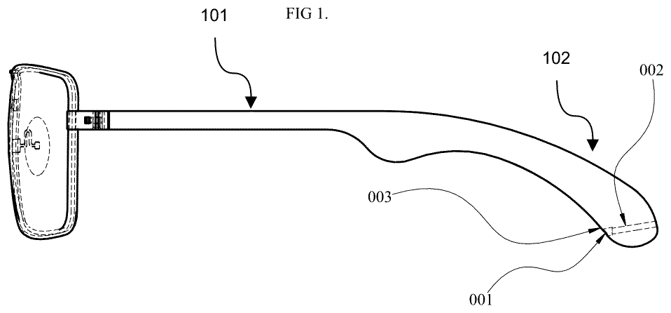

Referring to FIG. 1., the figure illustrates a side view of an eyewear device, specifically depicting an arm 101 with an earpiece 102. The device includes components designed to secure a retaining cable or cord. The arm 101 extends from the front, where a lens would typically be located, to the rear, where the earpiece 102 would rest behind the wearer's car. At the rear end of the earpiece 102, there is a through-hole 002 that passes completely through the material. This through-hole 002 is designed to accommodate a cable 004.

Adjacent to the through-hole 002, near the end or tip of the earpiece 102, is a counterbore hole 001. The counterbore hole 001 is a wider opening that intersects with the through-hole 002. This configuration allows for the insertion and securing of a cable 004. A melt bead 003 may rest in the counterbore hole 001 at the end of the through-hole 002 closest to the arm 001. The melt bead 003 may be formed at the end of cable 004 that has been passed through the through-hole 002 and then melted or expanded to create a larger diameter that prevents it from passing back through the through-hole 002.

The arrangement of these components—the through-hole 002, counterbore hole 001, and melt bead 003—forms a mechanism for attaching a cable to the eyewear while allowing for adjustability. This design may help prevent abrasion to the wearer's car by securing the cable within the earpiece 102 structure rather than having it rest directly on the car.

In some aspects, the counterbore hole 001 may be positioned adjacent to the through-hole 002 in the earpiece 102. The counterbore hole 001 may be configured to receive an enlarged portion of the cable 004. In some cases, the enlarged portion of the cable 004 may comprise a melt bead 003 formed at an end of the cable 004. The melt bead 003 may be formed by applying heat to the end of the cable 004, causing it to melt and form a bead that is larger in diameter than the through-hole 002. This melt bead 003 may be pulled into the counterbore hole 001, thereby securing the cable 004 within the through-hole 002 and preventing it from slipping back through the through-hole 002. This configuration may provide a secure and adjustable means for attaching a cable to the eyewear, potentially reducing the risk of the eyewear falling off during use.

In some cases, the through-hole 002 may be positioned near the end of the earpiece 102, allowing the cable to extend from the end of the earpiece 102 when the eyewear is worn. This positioning may help to prevent the cable from interfering with the wearer's comfort or the fit of the eyewear. In other cases, the through-hole 002 may be positioned at a different location on the earpiece 102, depending on the specific design and intended use of the eyewear.

In some embodiments, the through-hole 002 may be formed during the manufacturing process of the earpiece 102, such as by drilling or molding. In other embodiments, the through-hole 002 may be formed after the earpiece 102 has been manufactured, such as by drilling or other suitable methods. The through-hole 002 may be formed in a manner that ensures a smooth and clean opening, to prevent damage to the cable and to ensure a secure and reliable connection between the cable and the earpiece 102.

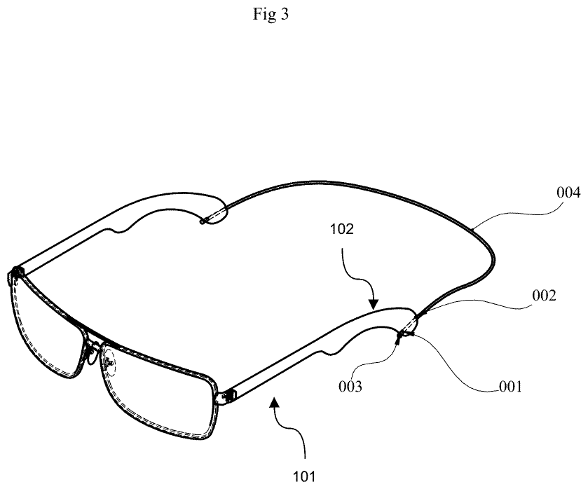

Referring to FIG. 3, a melt bead 003 is illustrated at the junction of the through-hole 002 and the counterbore hole 001. This melt bead 003 is formed at the end of the cable 004, creating a larger diameter that prevents the cable 004 from passing back through the through-hole 002. The cable 004 extends from the earpiece 102, forming a loop that would typically wrap around the wearer's head or neck to secure the eyewear in place. The cable 004 is shown as a thin, flexible line that follows the contour of the earpiece 102.

This configuration of the through-hole 002, counterbore hole 001, melt bead 003, and cable 004 forms a mechanism for attaching and adjusting the retaining cable to the eyewear while integrating it into the structure of the earpiece 102. This design may help prevent abrasion to the wearer's car by securing the cable within the earpiece 102 structure rather than having it rest directly on the car.

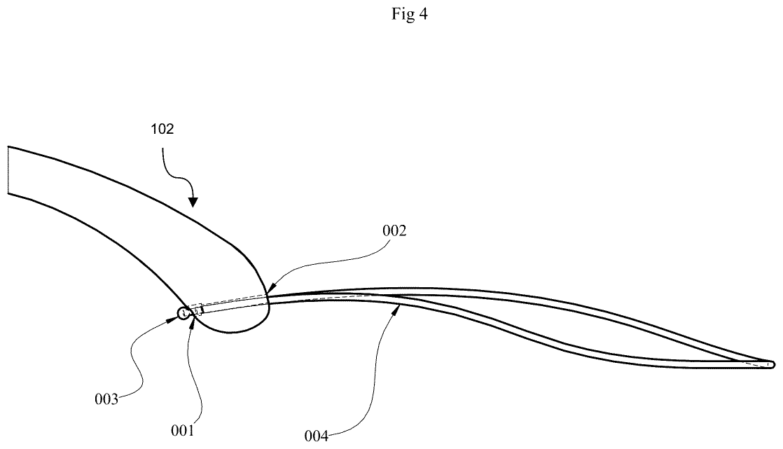

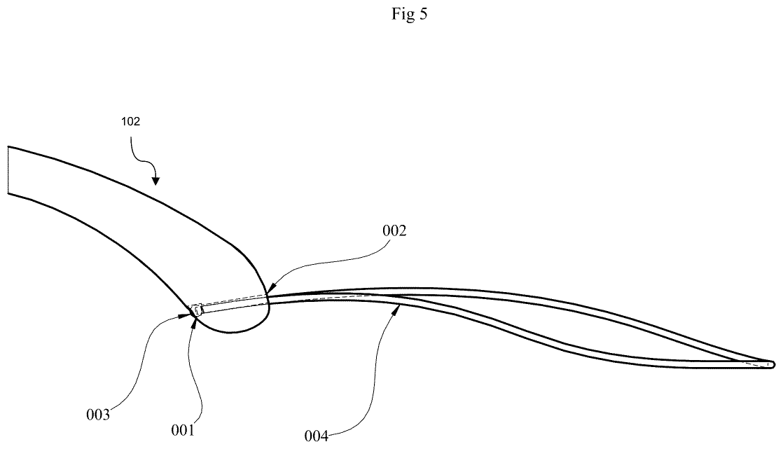

FIGS. 4 and 5 illustrate side views of an eyewear device, specifically depicting an arm 101 with an earpiece 102. At the rear end of the earpiece 102, there is a through-hole 002 that passes completely through the material. This through-hole 002 is designed to accommodate cable 004. A cable 004 is inserted through the through-hole 002 in FIG. 4, and a melt bead 003, of a larger diameter than the cable 004, is formed. The cable 004 is then pulled back into the through-hole 002, causing the melt bead 003 to stop in the counterbore hole 001.

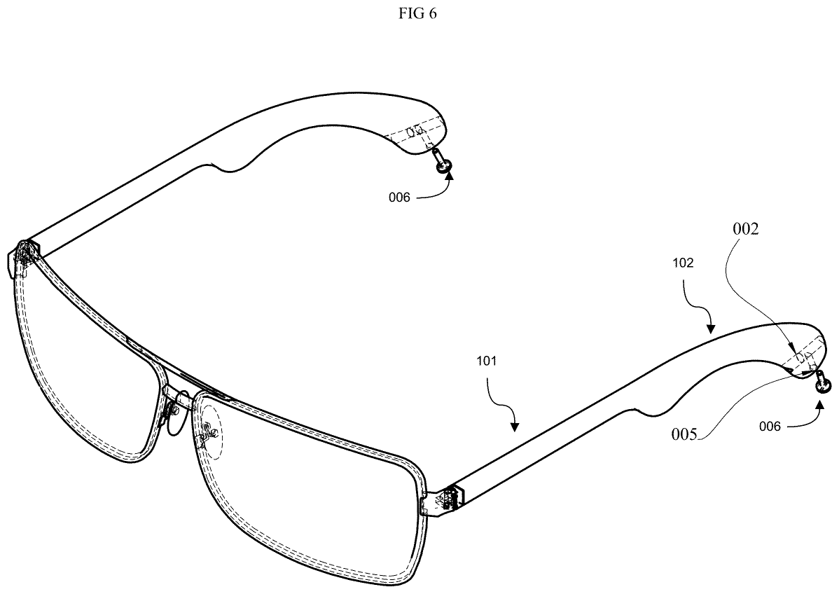

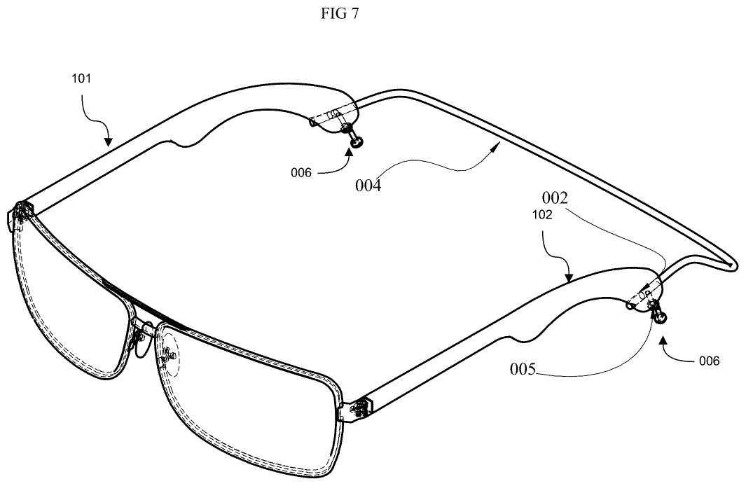

FIGS. 6 and 7 illustrate perspective views of an eyewear device with an integrated retention system. The device comprises a frame with two arms 101, each extending from the front portion that holds the lenses and terminating in an earpiece 102. Each earpiece 102 incorporates a through-hole 002 near its end. These through-holes 002 are designed to accommodate a cable 004, which is shown passing through the through-holes 002 on both earpieces 102, creating a loop that can secure the eyewear around the wearer's head.

Adjacent to each through-hole 002, near the end or tip of the earpiece 102, is a threaded tap hole 005. The threaded tap holes 005 may intersect with the through-holes 002. This configuration allows for the insertion and securing of the cable 004 with a screw 006.

In some aspects, the eyewear device may comprise a pair of eyeglasses having earpieces 102, each earpiece including a through-hole 002. A cable 004 may be threaded through the through-holes 002 of both temple arms. A means for securing the cable within each through-hole may be provided. This means for securing the cable may include a threaded tap hole 005 intersecting the through-hole 002, configured to receive a screw 006. The screw 006 may be inserted into the threaded tap hole 005 to secure the cable 004 within the through-hole 002, thereby preventing it from slipping back through the through-hole 002. This configuration may provide a secure and adjustable means for attaching a cable to the eyewear, potentially reducing the risk of the eyewear falling off during use.

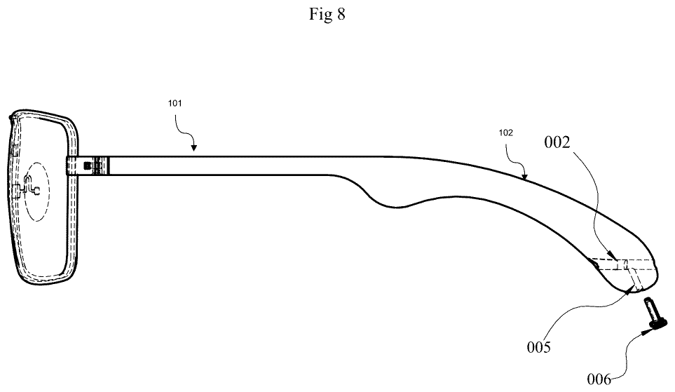

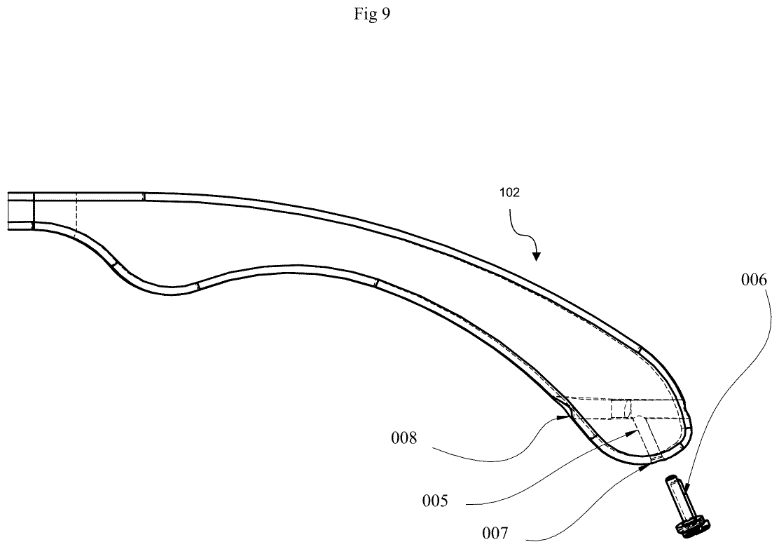

FIGS. 8-11 illustrate multiple views of an eyewear device depicting an arm 101 with an earpiece 102. The device includes components designed to secure a retaining cable or cord. The arm 101 extends from the front, where a lens would typically be located, to the rear where the earpiece 102 would rest behind the wearer's car. At the rear end of the earpiece 102, there is a through-hole 002 that passes completely through the material. This through-hole 002 is designed to accommodate a cable 004.

Adjacent to the through-hole 002, near the end or tip of the earpiece 102, is a threaded tap hole 005. The threaded tap hole 005 intersects with the through-hole 002. This configuration allows for the insertion and securing of a cable 004. A screw 006 is shown extending from the threaded tap hole 005.

In some aspects, the securing mechanism of the eyewear device may comprise a threaded tap hole 005 intersecting the through-hole 002 and a screw 006 configured to engage the threaded tap hole 005 to secure the cable 004. The screw 006 may be inserted into the threaded tap hole 005 to secure the cable 004 within the through-hole 002, thereby preventing it from slipping back through the through-hole 002. This configuration may provide a secure and adjustable means for attaching a cable to the eyewear, potentially reducing the risk of the eyewear falling off during use.

In some embodiments, the screw 006 may be recessed within a screw counterbore 007 adjacent to the threaded tap hole 005. The screw counterbore 007 may be configured to receive a head of the screw 006, thereby allowing the screw 006 to be flush with the surface of the earpiece 102. This configuration may provide a more streamlined appearance for the eyewear device while still providing a secure and adjustable means for attaching a cable to the eyewear. The screw counterbore 007 may be formed during the manufacturing process of earpiece 102, such as by drilling or molding, or it may be formed after earpiece 102 has been manufactured, such as by drilling or other suitable methods. The screw counterbore 007 may be formed in a manner that ensures a smooth and clean opening to prevent damage to the screw 006 and to ensure a secure and reliable connection between the screw 006 and the threaded tap hole 005.

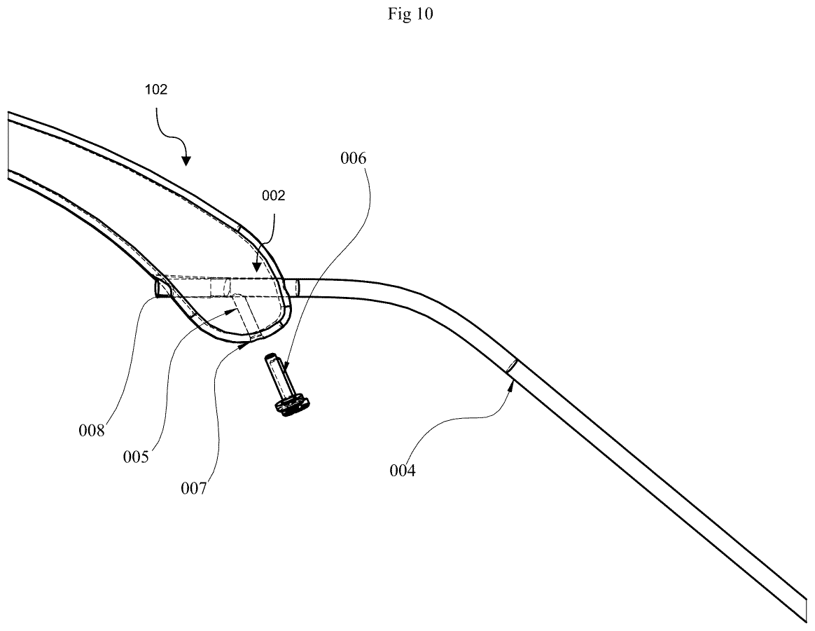

Referring to FIG. 10, the figure illustrates a sectional view of a portion of an eyewear retention device, focusing on the arrangement and interaction of the through-hole 002, threaded tap hole 005, screw 006, cable 004, and cable termination point 008 within the earpiece 102 structure. The earpiece 102 is shown as an elongated, curved structure that would typically rest behind a wearer's car.

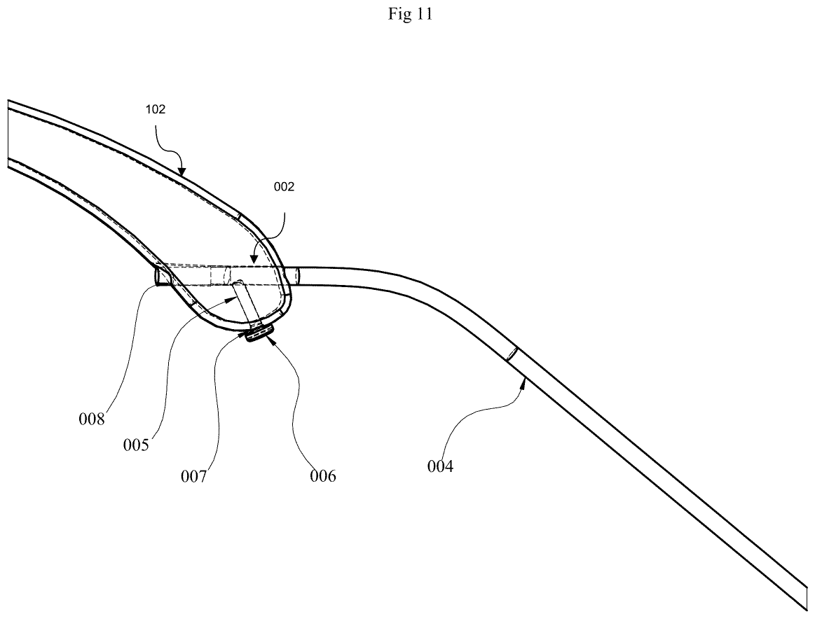

Referring to FIG. 11, a screw 006 is depicted inserted into the threaded tap hole 005. The screw 006 extends outward from the earpiece 102, passing through a screw counterbore 007. The screw 006 may be part of the mechanism for securing a cable to the eyewear.

A cable termination point 008 is visible within the through-hole 002.

The arrangement of the through-hole 002, threaded tap hole 005, screw 006, screw counterbore 007, cable 004, and cable termination point 008 forms a mechanism for attaching and potentially adjusting a retaining cable to the eyewear while integrating it into the structure of the earpiece 102. This design allows for the secure attachment of a cable while maintaining a streamlined appearance of the eyewear temple arm.

In some cases, the screw 006 may be recessed within a screw counterbore 007 adjacent to the threaded tap hole 005. The screw counterbore 007 may be configured to receive a head of the screw 006, thereby allowing the screw 006 to be flush with the surface of the earpiece 102. This configuration may provide a more streamlined appearance for the eyewear device while still providing a secure and adjustable means for attaching a cable to the eyewear. The screw counterbore 007 may be formed during the manufacturing process of earpiece 102, such as by drilling or molding, or it may be formed after earpiece 102 has been manufactured, such as by drilling or other suitable methods. The screw counterbore 007 may be formed in a manner that ensures a smooth and clean opening to prevent damage to the screw 006 and to ensure a secure and reliable connection between the screw 006 and the threaded tap hole 005.

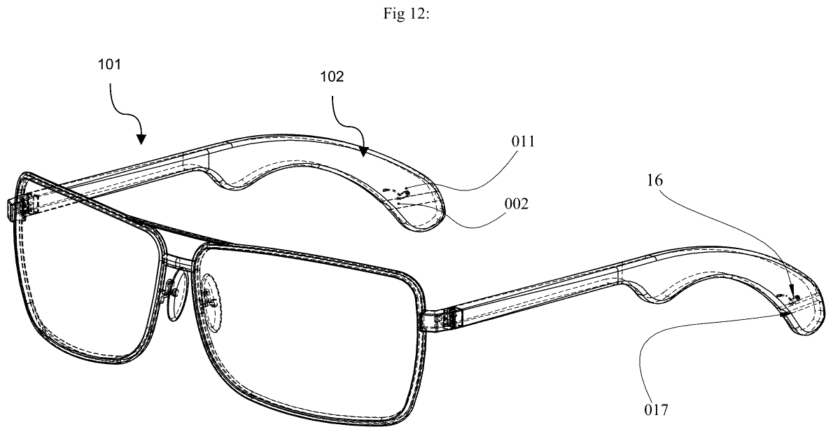

FIGS. 12-16 illustrate various aspects of an alternative embodiment of the eyewear retention system, focusing on a pivoting mechanism integrated into the earpiece for securing the cable. This embodiment may provide additional flexibility and case of adjustment compared to the previously described configurations.

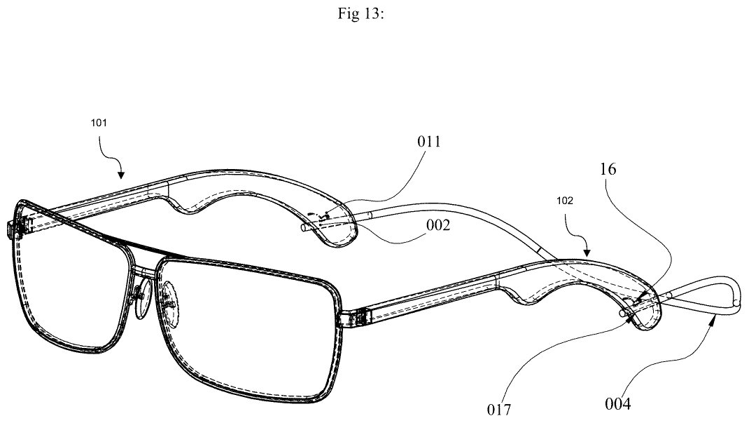

In some aspects, as shown in FIGS. 12 and 13, the earpiece 102 may incorporate a spring loaded mechanism 011. This mechanism may be positioned near the rear end of the earpiece 102 and may include a through-hole 002 designed to accommodate the cable 004. The spring loaded mechanism 011 may work in conjunction with a pivoting arm catch 16, which may be integrated into the structure of the earpiece 102.

The pivoting arm catch 16 may be designed with teeth or ridges that can engage with the cable 004. These teeth may provide a secure grip on the cable 004, allowing for precise adjustment and preventing unwanted slippage. In some embodiments, the teeth of the pivoting arm catch 16 may be angled or shaped in a way that allows the cable 004 to move easily in one direction while resisting movement in the opposite direction, facilitating easy adjustment of the cable tension.

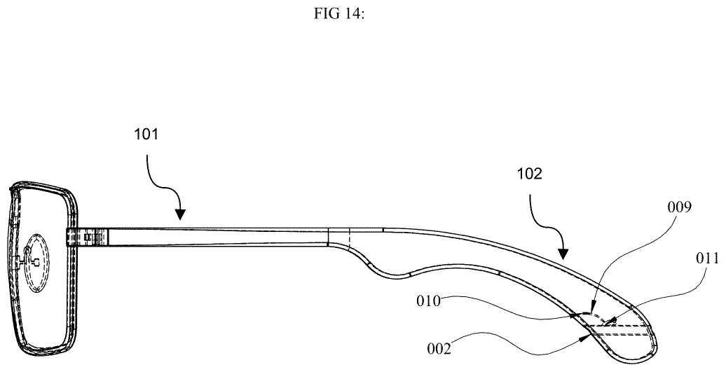

FIG. 14 provides a side view of the earpiece 102, revealing how the spring loaded mechanism 011 may be integrated into the structure. The spring 010 shown in this figure may provide the necessary tension to keep the pivoting arm catch 16 engaged with the cable 004. This tension may be adjustable, allowing users to customize the grip strength based on their preferences or the specific activities they are engaging in.

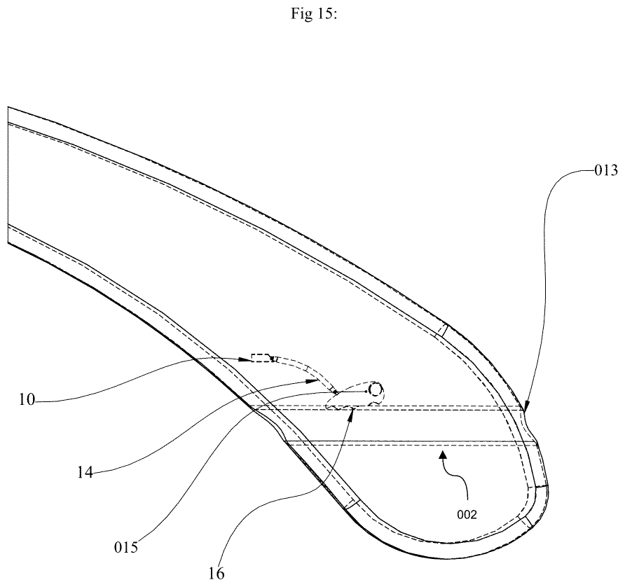

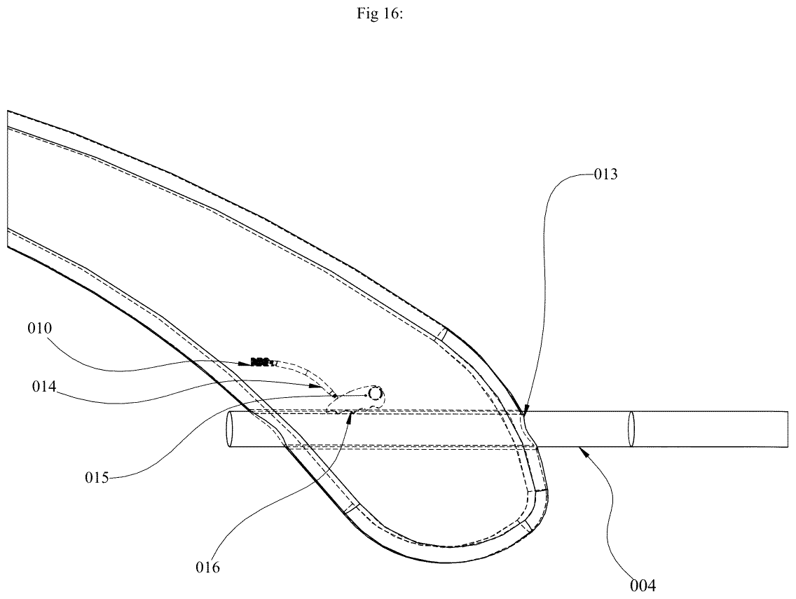

FIGS. 15 and 16 offer more detailed views of the pivoting mechanism 015 and how it interacts with the cable 004. The pivoting mechanism 015 may be designed to allow for smooth movement of the cable 004 through the earpiece 102 while still providing a secure hold when needed. In some embodiments, the pivoting mechanism 015 may include a spring hinge or spring-loaded mechanism 14, which may work in conjunction with the pivoting arm catch 16 to provide a balanced combination of flexibility and security.

The cable entrance 013, visible in FIGS. 15 and 16, may be designed to guide the cable 004 smoothly into the pivoting mechanism 015. This may help prevent wear and tear on the cable 004 and ensure consistent performance of the retention system over time.

In some aspects, the pivoting mechanism 015 may be designed to be easily accessible to the user, allowing for quick adjustments to the cable tension or position. This accessibility may be balanced with a streamlined design that integrates seamlessly with the overall aesthetic of the eyewear.

The combination of the spring loaded mechanism 011, pivoting arm catch 16 with teeth, and the pivoting mechanism 015 may provide a versatile and secure method for attaching and adjusting the retention cable 004. This configuration may offer advantages in terms of case of use, durability, and adaptability to different user needs and preferences.

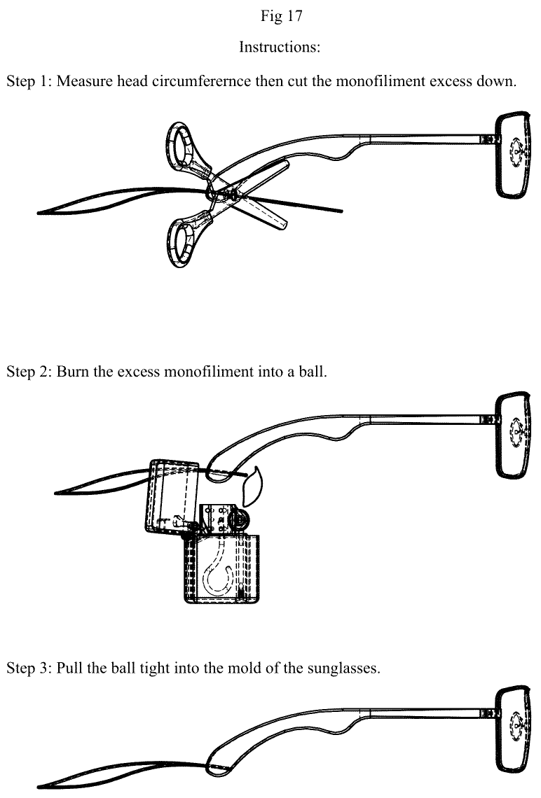

Referring to FIG. 17, the figure illustrates a series of orthogonal views depicting a process for attaching a retention cable to eyewear. The figure is divided into three steps, each showing a side view of a pair of eyeglasses with a temple arm.

In the first step, the eyeglasses are shown with a monofilament cable 004 threaded through the temple arm 101. The cable 004 extends beyond the end of the temple arm 101, and a cutting tool, such as scissors, is positioned to cut the excess length of the monofilament cable 004. The monofilament cable 004 may be made of a variety of materials, including but not limited to nylon, polyester, or other suitable synthetic materials. The monofilament cable 004 may be selected for its strength, flexibility, and resistance to wear and tear, making it suitable for use in an eyewear retention system.

In the second step, the eyeglasses are shown with the monofilament cable 004 trimmed to the desired length. A heat source, such as a lighter, is depicted near the end of the cable 004, illustrating the process of heating the end of the monofilament cable 004. The heat source may melt the end of the monofilament cable 004, causing it to form a bead or bulge at its end. This bead or bulge, referred to herein as a melt bead 003, may be larger than the through-hole 002 in the temple arm 101, preventing the monofilament cable 004 from slipping back through the through-hole 002.

In the third step, the eyeglasses are shown with the monofilament cable 004 fully installed. The melt bead 003 formed at the end of the cable 004 is pulled tight into a counterbore hole 001 in the temple arm 101. The counterbore hole 001 may be a wider opening that intersects with the through-hole 002, allowing the melt bead 003 to be securely seated within the counterbore hole 001. This configuration secures the monofilament cable 004 within the through-hole 002, preventing it from slipping back through the through-hole 002 and providing a secure and adjustable means for attaching a cable to the eyewear.

In some aspects, the process of attaching a monofilament cable 004 to eyewear as illustrated in FIG. 17 may provide a simple, efficient, and reliable method for securing eyewear. The use of a monofilament cable 004 and a melt bead 003 may provide a lightweight and adjustable retention system that can be easily installed and adjusted as needed. Furthermore, the use of a monofilament cable 004 may reduce the risk of abrasion to the wearer's car, as the cable 004 may be smoothly integrated into the structure of the temple arm 101.

In some embodiments, the cable 004 used in the eyewear retention system may be made of various materials. For instance, the cable 004 may be made of metal, carbon fiber, or plastic. The choice of material for the cable 004 may depend on various factors, such as the desired strength, flexibility, and durability of the cable 004, as well as the specific design and intended use of the eyewear. In some cases, the cable 004 may be made of a monofilament, which is a single filament of synthetic fiber. The monofilament cable 004 may be lightweight and flexible, making it suitable for use in an eyewear retention system. The diameter of the cable 004 may vary, for example, and not meant to be limiting, having a diameter of 0.15 mm to 1.5 mm.

In some aspects, the eyewear frame, including the arm 101 and the earpiece 102, may be made of various materials. For instance, the eyewear frame may be made of metals such as titanium, steel, stainless steel, or carbon fiber. These metals may provide a strong and durable structure for the eyewear frame, potentially enhancing the longevity and performance of the eyewear. In some cases, the eyewear frame may be made of plastics such as zyl and nylon. These plastics may offer a lightweight and flexible alternative to metal frames, potentially improving the comfort and fit of the eyewear. In other embodiments, the eyewear frame may be made of bamboo, wood, or acetate. These materials may provide a unique aesthetic appeal for the eyewear, potentially enhancing its visual appeal and marketability. The choice of material for the eyewear frame may depend on various factors, such as the desired strength, flexibility, and aesthetic appeal of the eyewear, as well as the specific design and intended use of the eyewear.

In some embodiments, the counterbore hole 001 may have a diameter that varies between 0.20 mm to 1.55 mm. The specific diameter of the counterbore hole 001 may be selected based on various factors, such as the size and type of cable 004 to be used, the specific design and material of the earpiece 102, and the desired fit and security of the cable 004 within the counterbore hole 001. The counterbore hole 001 may be formed during the manufacturing process of the earpiece 102, such as by drilling or molding, or it may be formed after the earpiece 102 has been manufactured, such as by drilling or other suitable methods. The counterbore hole 001 may be formed in a manner that ensures a smooth and clean opening, to prevent damage to the cable 004 and to ensure a secure and reliable connection between the cable 004 and the counterbore hole 001.

In some cases, the cable 004 may be easily changed or replaced. For instance, the existing cable 004 may be cut, allowing it to be removed from the through-hole 002. A new cable 004 may then be inserted into the through-hole 002, passing through the earpiece 102 and extending beyond the end of the earpiece 102. The end of the new cable 004 may be trimmed to the desired length, and a heat source may be applied to the end of the cable 004 to form a new melt bead 003. The melt bead 003 may be larger in diameter than the through-hole 002, preventing the new cable 004 from slipping back through the through-hole 002. The melt bead 003 may be pulled into the counterbore hole 001, thereby securing the new cable 004 within the through-hole 002. This process may allow for easy replacement of the cable 004, potentially extending the lifespan of the eyewear and allowing for customization of the cable 004 based on the wearer's preferences or needs.

Different features, variations, and multiple embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

The embodiments of a device, system, and method of an eyewear retention system may be utilized individually, concurrently, or in any sequential combination.

Those skilled in the art to which this application relates will appreciate that other and further additions, deletions, substitutions and modifications may be made to the described embodiments. The specification is not to be taken in a limiting sense, but is made merely for the purpose of describing the general principles of exemplary embodiments; many additional embodiments of this invention are possible. It is understood that no limitation of the scope of the invention is thereby intended.

The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

The invention is described with such embodiments, but the invention is not limited to any embodiment. The scope of the invention is limited only by the claims and the invention encompasses numerous alternatives, modifications and equivalents. Several specific details are set forth in the description to provide a thorough understanding of the invention. These details are provided for the purpose of example and the invention may be practiced according to the claims without some or all of these specific details. In general, the order of the steps of disclosed processes may be altered within the scope of the invention.

Unless otherwise indicated, the drawings are intended to be read (e.g., arrangement of parts, proportion, degree, etc.) together with the specifications and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein.

Further, the described features, structures, or characteristics of the present disclosure may be combined in any suitable manner in one or more embodiments. In the Detailed Description, numerous specific details are provided for a thorough understanding of embodiments of the disclosure. However, one skilled in the relevant art will recognize that the embodiments of the present disclosure can be practiced without one or more of the specific details or with other methods, components, materials, and so forth. In other instances, well-known structures, materials, or operations are not shown or described in detail to avoid obscuring aspects of the present disclosure. Any alterations and further modifications in the illustrated devices and such further application of the principles of the invention as illustrated herein are contemplated as would normally occur to one skilled in the art to which the invention relates.

A number of implementations have been described. Nevertheless, it will be understood that various modifications may be made without departing from the spirit and scope of the disclosure. Accordingly, other implementations are within the scope of the following claims.

What is claimed:

1. A device for securing eyewear, comprising:
an earpiece having a through-hole;
a cable passing through the through-hole; and
a securing mechanism configured to retain the cable within the through-hole.

2. The device of claim 1, wherein the securing mechanism comprises a counterbore hole adjacent to the through-hole, the counterbore hole configured to receive an enlarged portion of the cable.

3. The device of claim 2, wherein the enlarged portion of the cable comprises a melt bead formed at an end of the cable.

4. The device of claim 1, wherein the securing mechanism comprises a threaded tap hole intersecting the through-hole and a screw configured to engage the threaded tap hole to secure the cable.

5. The device of claim 4, further comprising a screw counterbore adjacent to the threaded tap hole, the screw counterbore configured to receive a head of the screw.

6. The device of claim 1, wherein the securing mechanism comprises a spring-loaded pivoting arm configured to engage the cable.

7. The device of claim 6, wherein the pivoting arm includes teeth configured to grip the cable.

8. A method for securing eyewear, comprising:
providing an earpiece of eyewear with a through-hole;
inserting a cable through the through-hole; and
securing the cable within the through-hole using a securing mechanism.

9. The method of claim 8, wherein securing the cable comprises forming an enlarged portion at an end of the cable and positioning the enlarged portion within a counterbore hole adjacent to the through-hole.

10. The method of claim 9, wherein forming the enlarged portion comprises melting the end of the cable to create a melt bead.

11. The method of claim 8, wherein securing the cable comprises engaging a screw within a threaded tap hole intersecting the through-hole to secure the cable.

12. The method of claim 11, further comprising positioning a head of the screw within a screw counterbore adjacent to the threaded tap hole.

13. The method of claim 8, wherein securing the cable comprises engaging a spring-loaded pivoting arm with the cable.

14. The method of claim 13, wherein the pivoting arm includes teeth configured to grip the cable.

15. An eyewear retention system, comprising:
a pair of eyeglasses having earpieces, each earpiece including a through-hole;
a cable threaded through the through-holes of both temple arms; and
a means for securing the cable within each through-hole.

16. The eyewear retention system of claim 15, wherein the means for securing the cable comprises a counterbore hole adjacent to each through-hole, the counterbore hole configured to receive an enlarged portion of the cable.

17. The eyewear retention system of claim 16, wherein the enlarged portion of the cable comprises a melt bead formed at an end of the cable.

18. The eyewear retention system of claim 15, wherein the means for securing the cable comprises a threaded tap hole intersecting each through-hole and a screw configured to engage the threaded tap hole to secure the cable.

19. The eyewear retention system of claim 18, further comprising a screw counterbore adjacent to each threaded tap hole, the screw counterbore configured to receive a head of the screw.

20. The eyewear retention system of claim 15, wherein the means for securing the cable comprises a spring-loaded pivoting arm configured to engage the cable, the pivoting arm including teeth configured to grip the cable.
